(19) United States
(12) Patent Application Publication
(10) Pub. No.: US 2025/0363417 A1
(43) Pub. Date: Nov. 27, 2025

(54) COMPUTER ARCHITECTURE FOR PREDICTING ENERGY CONSUMPTION OF MACHINE LEARNING INFERENCE

(71) Applicant: EdgeImpulse Inc., San Diego, CA (US)

(72) Inventors: Ivan TURASOV, Amsterdam (NL); Johannes Marinus Hendrikus KAMPHUIS, Ede (NL)

(21) Appl. No.: 19/213,888

(22) Filed: May 20, 2025

Related U.S. Application Data
(60) Provisional application No. 63/650,453, filed on May 22, 2024.

(51) Int. Cl. G06N 20/00; G06N 3/0464

(52) U.S. Cl. CPC G06N 20/00; G06N 3/0464

(57) ABSTRACT

Processing circuitry of one or more computing devices obtains model property values associated with a machine learning model by analyzing the machine learning model by the processing circuitry. The processing circuitry determines, based on the model property values, performance counters associated with the machine learning model executing on a processor, by analyzing, using the processing circuitry, the machine learning model and stored data associated with the processor. The processing circuitry predicts, using a prediction model stored at the one or more computing devices, an energy consumption value of executing the machine learning model on the processor based on the performance counters.

### CROSS REFERENCE TO RELATED APPLICATIONS

This application claims the benefit of U.S. Provisional Patent Application No. 63/650,453, filed on May 22, 2024, titled “PREDICTING ENERGY CONSUMPTION OF MACHINE LEARNING INFERENCE,” the entire disclosure of which is incorporated herein by reference in its entirety for all purposes.

### FIELD

This disclosure relates generally to computer architectures for artificial intelligence. For example, aspects of the present disclosure relate to computer architectures for predicting energy consumption of machine learning inference operations on edge devices.

### BACKGROUND

Machine learning systems (or models), such as neural networks (e.g., deep neural networks) are widely used for numerous applications, such as generative operations (e.g., to generate images, language/text outputs, etc.), object detection, object classification, object tracking, big data analysis, among others.

Machine learning inference technology may be executed on resource-constrained devices such as edge devices. An example of an edge device is a thin device with limited processing hardware, memory hardware, battery power, and/or network interface capabilities. But due to the limited battery power of the edge devices, predicting the energy consumption of the machine learning inference technology may be desirable.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, the techniques described herein relate to an apparatus for predicting energy consumption of a machine learning model, including: at least one memory; and at least one processor coupled to the at least one memory and configured to: analyze a machine learning model to obtain model property values associated with the machine learning model; analyze the machine learning model and stored data to determine, based on the model property values, performance counters associated with the machine learning model; and predict, using a prediction model, an energy consumption value of executing the machine learning model based on the performance counters.

In some aspects, the techniques described herein relate to a method for predicting energy consumption of a machine learning model, the method including: analyzing a machine learning model to obtain model property values associated with the machine learning model; analyzing the machine learning model and stored data to determine, based on the model property values, performance counters associated with the machine learning model; and predicting, using a prediction model, an energy consumption value of executing the machine learning model based on the performance counters.

In some aspects, the techniques described herein relate to a non-transitory computer-readable medium is provided that has stored thereon instructions that, when executed by one or more processors, cause the one or more processors to: analyze a machine learning model to obtain model property values associated with the machine learning model; analyze the machine learning model and stored data to determine, based on the model property values, performance counters associated with the machine learning model; and predict, using a prediction model, an energy consumption value of executing the machine learning model based on the performance counters.

In some aspects, the techniques described herein relate to an apparatus for predicting energy consumption of a machine learning model, including: at least one memory; and at least one processor coupled to the at least one memory and configured to: means for analyzing a machine learning model to obtain model property values associated with the machine learning model; means for analyzing the machine learning model and stored data to determine, based on the model property values, performance counters associated with the machine learning model; and means for predicting, using a prediction model, an energy consumption value of executing the machine learning model based on the performance counters.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates the training and use of a machine-learning algorithm, in accordance with aspects of the disclosure.

FIG. 2 illustrates an example neural network, in accordance with aspects of the disclosure.

FIG. 3 illustrates the training of an image recognition machine learning algorithm, in accordance with aspects of the disclosure.

FIG. 4 illustrates a convolutional neural network, in accordance with aspects of the disclosure.

FIG. 5 is a block diagram of a computing device, in accordance with aspects of the disclosure.

FIG. 6 illustrates an example hierarchy of machine learning classes, in accordance with aspects of the disclosure.

FIG. 7 illustrates an example convolution layer principle, in accordance with aspects of the disclosure.

FIG. 8 illustrates an example framework for convolutional neural network energy estimation, in accordance with aspects of the disclosure.

FIG. 9 illustrates an example framework for digital signal processing energy estimation, in accordance with aspects of the disclosure.

FIG. 10 illustrates an example platform structure for collecting data to build an energy consumption estimator, in accordance with aspects of the disclosure.

FIG. 11 illustrates an example of a prediction chain, in accordance with aspects of the disclosure.

FIG. 12 illustrates an example of inputs and outputs of digital signal processing estimators, in accordance with aspects of the disclosure.

FIG. 13 illustrates an example of an edge device configured to perform machine learning inference, in accordance with aspects of the disclosure.

FIG. 14 illustrates an example of a computing device configured to generate an estimate of energy consumption, in accordance with aspects of the disclosure.

FIG. 15 is a flowchart of an example technique for predicting energy consumption, in accordance with aspects of the disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. Various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Aspects described herein relate to use of Machine Learning (ML) models. Machine learning in general can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Different types of neural networks exist, such as convolutional neural networks (CNNs), recurrent neural networks (RNNs), generative adversarial networks (GANs), multilayer perceptron (MLP) neural networks, transformer-based neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding the output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Machine learning models can be trained to perform various functions and/or provide various types of outputs. For instance, some generative machine learning models can provide a conversational interface that uses natural language prompts as inputs, such as text or voice. In some examples, a user can provide an input prompt in natural language to the generative machine learning model, and the generative machine learning model can provide a response in natural language form. The input prompt and the output response can optionally be combined with one or more other types of information or data, such as images or files.

While machine learning models (e.g., neural networks) are powerful architectures capable of a wide range of useful tasks, such as recognizing objects in image data, or handling queries, they are likewise highly resource dependent. For example, neural networks may require significant compute, memory, power, and/or time resources for training and/or for inferencing. These resource requirements may significantly limit the ability to train and deploy neural networks to certain types of devices and for certain use cases. For instance, training of machine learning models may be a computationally intensive process that can take a relatively long time, a large quantity of training data, and many operations.

As discussed above, machine learning inference operations may be executed on resource-constrained devices such as edge devices. But due to the limited battery power of such devices, predicting the energy consumption of the machine learning inference technology may be desirable. For example, predicting the energy consumption may be useful to determine whether a given edge device is capable of executing a machine learning inference or whether other software on the edge device should not be executed to allow the machine learning inference to execute.

According to some implementations, processing circuitry (e.g., one or more processors) of one or more computing devices (e.g., server(s), laptop computer(s), or desktop computer(s)) obtains model property values associated with a machine learning model by analyzing the machine learning model. The model may execute on a different device such as an edge device. The model property values may reflect attributes such as a number of mathematical operations (e.g., multiply-accumulate operations) per layer.

The processing circuitry determines, based on the model property values, performance counters associated with the machine learning model inference on a processor, by analyzing, using the processing circuitry, the machine learning model and stored data associated with the processor. The performance counters may reflect memory or bus accesses, which can contribute to power consumption. Based on the model property values and the performance counters, the processing circuitry predicts an energy consumption value using a prediction model.

Aspects of the present disclosure may be implemented as part of a computer system. The computer system may be one physical machine, or may be distributed among multiple physical machines, such as by role or function, or by process thread in the case of a cloud computing distributed model. In various examples, aspects of the technology may be configured to run in virtual machines that in turn are executed on one or more physical machines. It will be understood by persons of skill in the art that features of the technology may be realized by a variety of different suitable machine implementations.

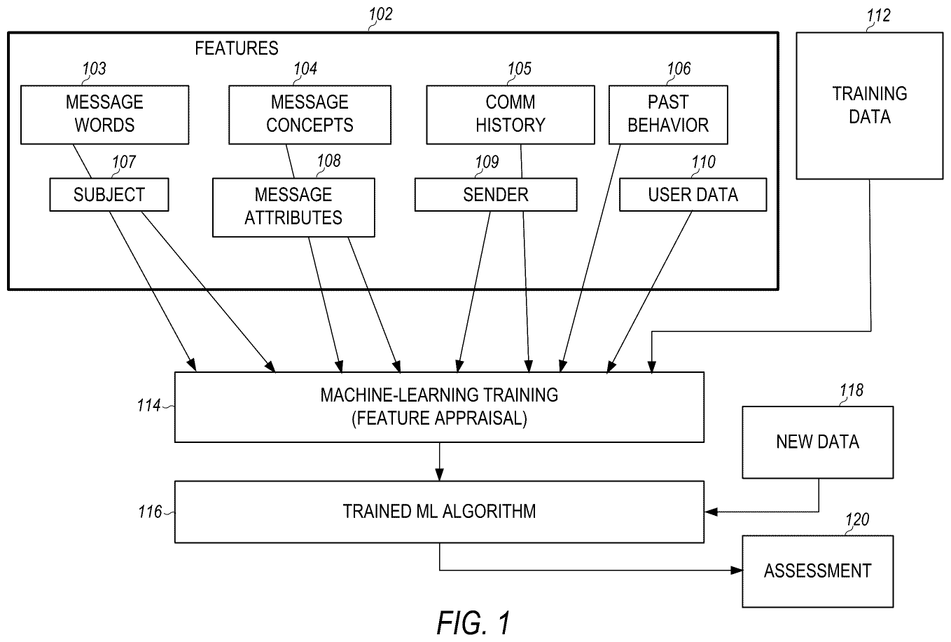

FIG. 1 illustrates the training and use of a machine-learning algorithm, according to some example aspects. In some example aspects, machine-learning algorithms or tools are utilized to perform operations associated with machine learning tasks, such as image recognition or machine translation.

Machine learning involves providing computing devices with an ability to perform certain tasks without being explicitly programmed to perform those tasks. In traditional computing, a programmer would encode instructions (e.g., to solve a quadratic equation using the quadratic formula), and the computer would perform those exact instructions. In contrast, in machine learning, a computer could be provided with examples of images of elephants and be trained to determine which images have and lack depictions of elephants, without the programmer encoding explicit instructions as to how to identify an elephant. Machine learning explores the study and construction of algorithms, also referred to herein as tools, which may learn from existing data and make predictions about new data. Such machine-learning tools operate by building a model from example training data 112 to make data-driven predictions or decisions expressed as outputs or assessments 120. Although example aspects are presented with respect to a few machine-learning tools, the principles presented herein may be applied to other machine-learning tools.

In some aspects, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (e.g., to determine whether an object is an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of a machine learning algorithm in pattern recognition, classification, and regression. Features may be of different types, such as numeric features, strings, and graphs.

In some aspects, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example aspects, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning algorithm 116.

When the machine-learning algorithm 116 is used to perform an assessment, new data 118 is provided as an input to the trained machine-learning algorithm 116, and the machine-learning algorithm 116 generates the assessment 120 as output. For example, when a message is checked for an action item, the machine-learning algorithm utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model, and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs and is evaluated over several epochs to more reliably provide the output that is specified as corresponding to the given input for the greatest number of inputs for the training dataset. In another example, for an unsupervised learning phase, a model is developed to cluster the dataset into n groups and is evaluated over several epochs as to how consistently it places a given input into a given group and how reliably it produces the n desired clusters across each epoch.

Once an epoch is executed, the models are evaluated, and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model, satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs-having reached a performance plateau-the learning phase for the given model may terminate before the epoch number/computing budget is reached.

Once the learning phase is complete, the models are finalized. In some example aspects, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

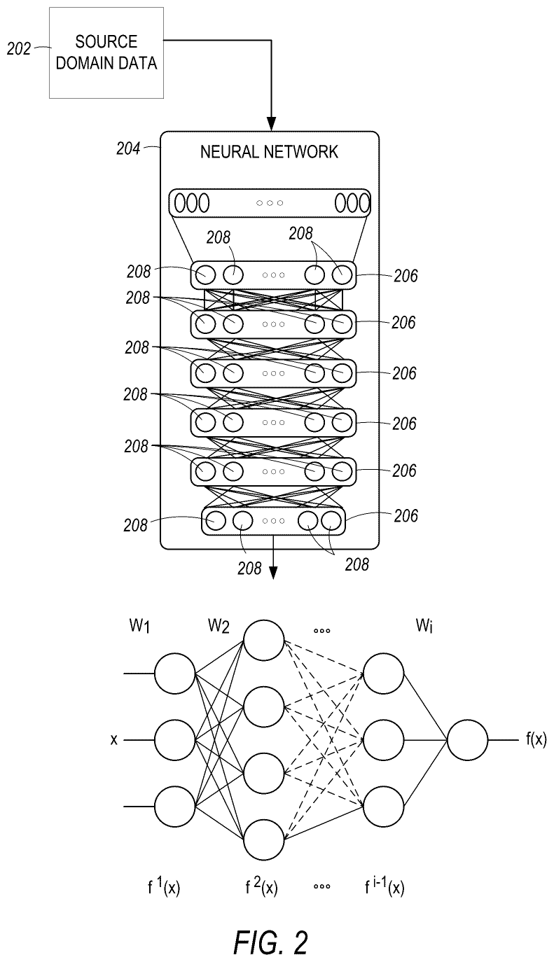

FIG. 2 illustrates an example of a neural network 204, in accordance with aspects of the disclosure. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at f¹(x), f²(x), . . . , fⁱ⁻¹(x), until finally the output f(x) is computed.

In some example aspects, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which includes multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

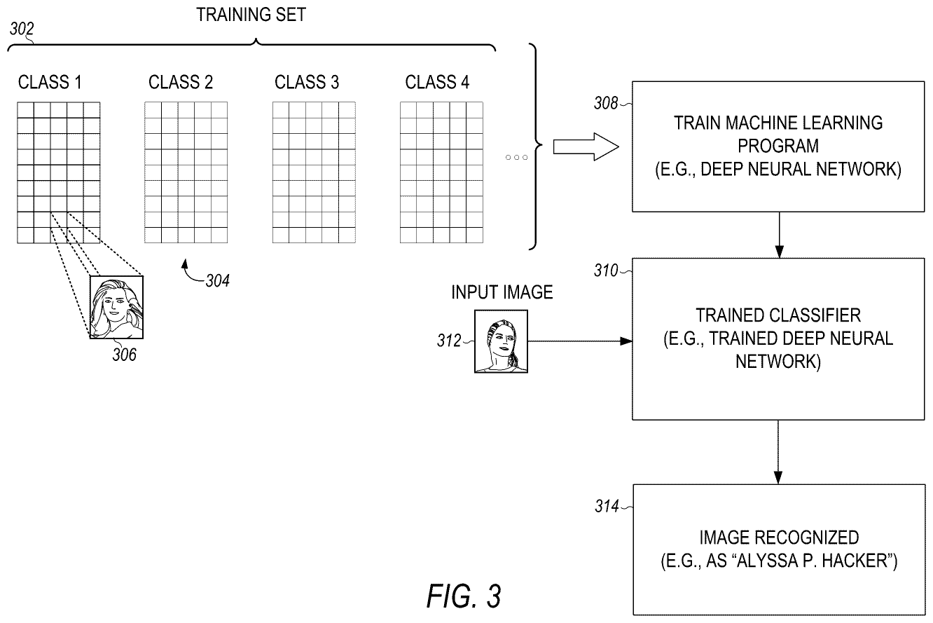

FIG. 3 illustrates the training of an image recognition machine learning algorithm, in accordance with aspects of the disclosure. The machine learning algorithm may be implemented by one or more computing devices. A training set 302 includes multiple classes 304. Each class 304 includes multiple images 306 associated with the class. Each class 304 may correspond to a type of object in the image 306 (e.g., a digit 0-9, a man or a woman, a cat or a dog, etc.). In some cases, the machine learning algorithm is trained to recognize images of various persons (i.e., to map a photograph of a person to the person's name), and each class 304 corresponds to each person, with each individual class 304 corresponding to an individual person (e.g., one class corresponds to Alyssa P. Hacker, one class corresponds to Ben Bitdiddle, etc.).

At block 308 the machine learning algorithm is trained, for example, using a deep neural network. A trained classifier 310 (e.g., the trained deep neural network), generated by the training of block 308, receives an input image 312, and at block 314 the image is recognized. For example, if the image 312 is a photograph of Alyssa P. Hacker, the classifier recognizes the image as corresponding to Alyssa P. Hacker at block 314. The classifier may include a DNN, as illustrated by the circle with the circular arrows.

FIG. 3 illustrates the training of a classifier, according to some example aspects. A machine learning algorithm is designed for recognizing faces, and a training set 302 includes data that maps a sample to a class 304 (e.g., a class includes all the images of purses). The classes may also be referred to as labels. Although implementations presented herein are presented with reference to object recognition, the same principles may be applied to train machine-learning algorithms used for recognizing any type of items.

The training set 302 includes a plurality of images 306 for each class 304 (e.g., image 306), and each image is associated with one of the categories to be recognized (e.g., a class). The machine learning algorithm is trained 308 with the training data to generate a classifier 310 operable to recognize images. In some example aspects, the machine learning algorithm is a DNN. When an input image 312 is to be recognized, the classifier 310 analyzes the input image 312 to identify the class corresponding to the input image 312.

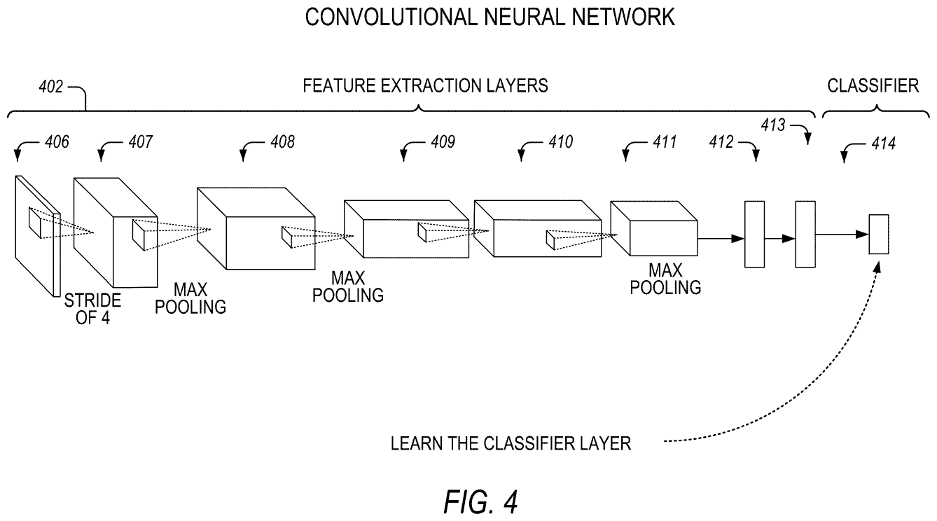

FIG. 4 illustrates a convolutional neural network, according to some example aspects. Training a classifier of the convolutional neural network may be accomplished with feature extraction layers 402 and classifier 414. Each image is analyzed in sequence by a plurality of layers 406-413 in the feature-extraction layers 402.

With the development of deep convolutional neural networks, the focus in face recognition has been to learn a good face embedding-based classifier, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example aspects, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using the reduced representation instead of the complete initial data. DNN utilizes a stack of layers, where each layer performs a function. For example, the layer could be a convolution, a non-linear transform, the calculation of an average, etc. Eventually the DNN produces outputs by classifier 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407, 408, 409, 410, 411, 412, and 413. The stride controls how the filter convolves around the input volume. “Stride of 4” refers to the filter convolving around the input volume four units at a time. Max pooling refers to down-sampling by selecting the maximum value in each max pooled region.

In some example aspects, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

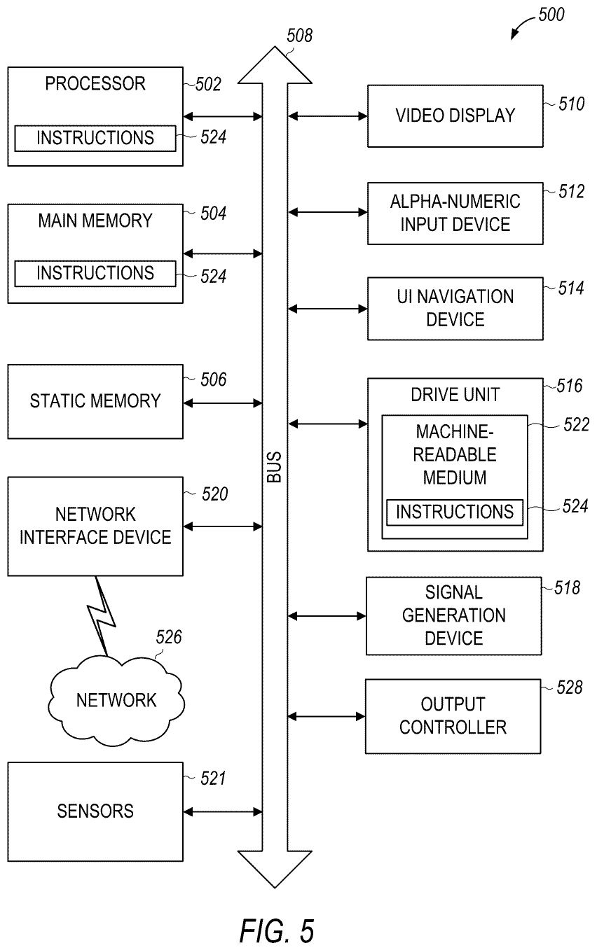

FIG. 5 illustrates a circuit block diagram of a computing device 500 in accordance with aspects of the disclosure. In aspects of the disclosure, components of the computing device 500 may store or be integrated into other components shown in the circuit block diagram of FIG. 5. For example, portions of the computing device 500 may reside in the processor 502 and may be referred to as “processing circuitry.” Processing circuitry may include processing hardware, for example, one or more central processing units (CPUs), one or more graphics processing units (GPUs), and the like. In alternative aspects, the computing device 500 may operate as a standalone device or may be connected (e.g., networked) to other computers. In a networked deployment, the computing device 500 may operate in the capacity of a server, a client, or both in server-client network environments. In an example, the computing device 500 may act as a peer machine in peer-to-peer (P2P) (or other distributed) network environment. As used herein, the phrases P2P, device-to-device (D2D) and sidelink may be used interchangeably. The computing device 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing device 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing device 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing device 500 may additionally include a drive unit 516 (or another storage device), a signal generation device 518 (e.g., a speaker), a network interface device 520, and one or more sensors 521, such as a global positioning system (GPS) sensor, compass, accelerometer, or other sensor. The computing device 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing device 500. In an example, one or any combination of the hardware processor 502, the main memory 504, the static memory 506, or the drive unit 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing device 500 and that cause the computing device 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

Energy consumption is a crucial consideration in edge computing, particularly in the context of edge machine learning (ML). Edge ML refers to the practice of running machine learning models on edge devices, which are typically closer to the source of data generation compared to cloud-based computing.

While the focus in the development of conventional ML models has traditionally been on accuracy and speed, energy efficiency becomes of utmost importance with ML models being deployed on edge devices, often times operating on battery power.

Energy efficiency is especially problematic in the context of tiny ML-a subset of edge ML, specifically targeting the most constrained devices such as microcontrollers or other embedded systems, which have very limited computational, memory, and energy resources.

Tiny ML models are designed to be highly efficient and compact, with optimized algorithms and architectures that can run locally on such devices. These models are typically trained on a larger host machine and then flashed to the constrained target device, where they are used for inference.

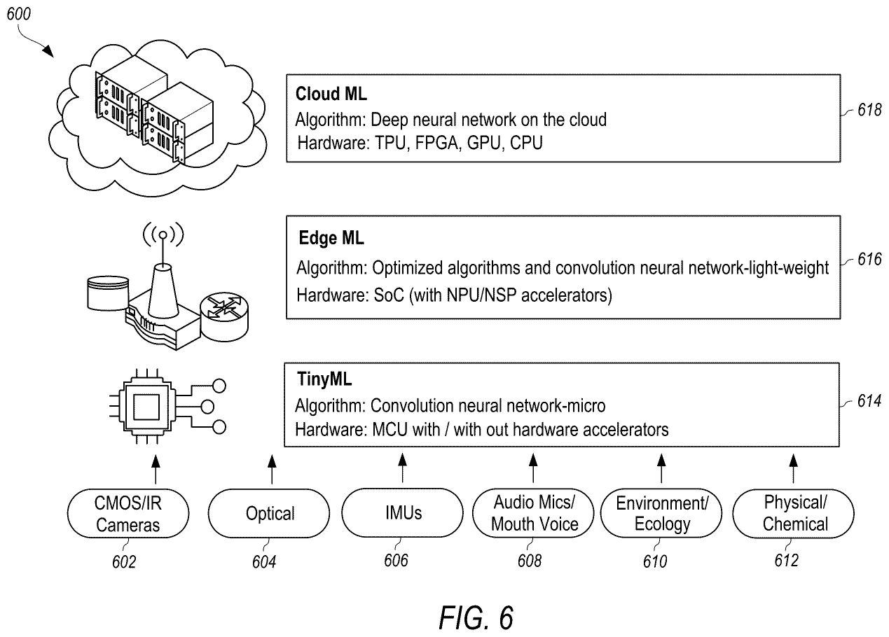

FIG. 6 illustrates an example hierarchy 600 of ML classes. As shown, Complementary metal-oxide semiconductor (CMOS)/infrared (IR) cameras 602, optical 604, inertial measurement units (IMUs) 606, audio microphones (mics)/mouth voice 608, environment/ecology 610, and physical/chemical 612 sensors feed to tiny ML 614. Edge ML 616 is more advanced or complex than tiny ML 614. Cloud ML 618 is more advanced or complex than edge ML 616. Tiny ML 614, edge ML 616, and cloud ML 618 receive input from the sensors 602-612. Tiny ML 614 uses the algorithm of convolutional neural network and hardware of microcontroller unit (MCU) with or without hardware accelerators. Edge ML 616 uses optimized algorithms and convolutional neural networks (e.g., light weight) and hardware of system on a chip (SoC) with neural processing unit (NPU)/neural signal processor (NSP) accelerators. Cloud ML 618 uses the algorithm of deep neural network on the cloud and hardware of tensor processing unit (TPU), field-programmable gate array (FPGA), graphics processing unit (GPU), and/or central processing unit (CPU).

Some implementations are related to an inference energy estimation framework for edge ML 616 devices. Some implementations estimate energy consumption of tiny ML 614 models' inference on constrained edge devices given the architecture of the model and a type of device as inputs. Some implementations may assist in enabling developers to create and deploy machine learning models on small, low-power devices such as microcontrollers and sensors.

Some schemes leverage performance monitor counters (PMCs) and/or simulations to determine energy use of ML models executing on edge devices. Some disadvantages of these schemes include that PMCs do not provide per-processor results and simulations may utilize significant time overhead.

ML includes, among other things, building models to enable computers to “learn” from data. Different ML techniques and model types are applied to either classification tasks, where the ML model classifies an input sample into one of predefined categories, or regression tasks, where a model predicts or estimates a continuous value based on one or more input values.

A convolutional neural network (CNN) is a ML model that is used to extract features (like edges, shapes) from input images to classify them in one of categories. CNNs consist of different types of layers, mainly convolutional layers (e.g., pointwise convolution, depthwise convolution) and activation layers.

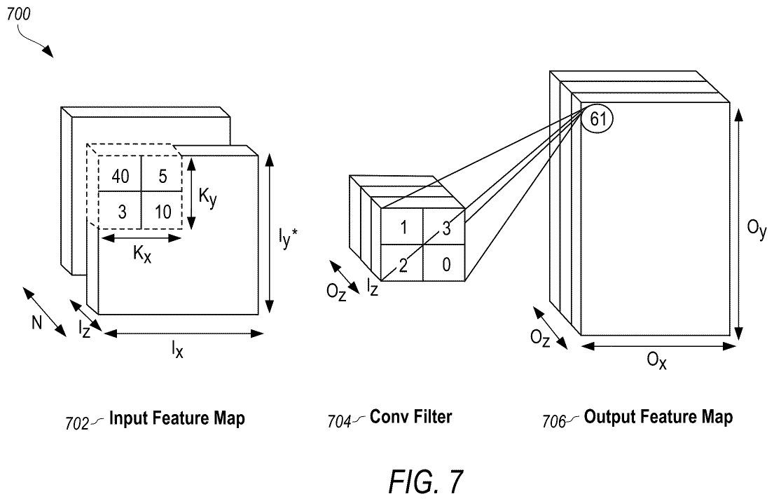

FIG. 7 illustrates an example convolution layer principle 700. As shown, an input feature map 702 is passed through a convolutional (conv) filter 704 to obtain an output feature map 706.

A Multiply-Accumulate (MAC) operation refers to the combination of a multiplication and an accumulation (addition) operation. In the context of neural networks and machine learning, MAC operations are at the heart of many computational tasks. During a MAC operation, a pair of values are multiplied, and the result is added to an accumulator.

In the context of the convolutional layer, each element of the filter is multiplied by the corresponding element in the input region, and the results are accumulated to produce a single output value for that position. The accumulation of multiplied values is effectively a MAC operation.

The number of MACs is often used to quantify the computational complexity of convolutional networks as they typically account for a large percentage of total operations in some CNNs. Some implementations include using digital signal processing to allow a computer to apply CNNs to timeseries data. Such a solution can enable many use cases such as keyword spotting for audio or gesture recognition for accelerometer data.

Training and inference are two distinct phases in the life cycle of a machine learning model. During the training phase, a machine learning model learns patterns and features from a labeled dataset. The use of patterns and features from the labeled dataset can involve adjusting the model's parameters through iterative optimization techniques to minimize the difference between predicted outputs and actual labels. Training typically uses a larger amount of computational resources and time compared to inference.

The inference phase involves applying the trained model to new, unseen data to make predictions or classifications. The inference phase phase may use less computational power compared to training and is often executed on devices with constrained resources, such as edge devices. More lightweight frameworks, which are typically subsets of training frameworks, are used for running inference on devices. Inference might, in some cases, not leverage operating system support, any standard C or C++ libraries, or dynamic memory allocation.

In the context of CNNs, training involves updating the weights of convolutional and other layers using backpropagation and gradient descent methods. Inference, however, consists of passing new data through the trained layers to obtain predictions without modifying the model's parameters.

Using machine learning techniques on edge devices introduces a set of unique challenges and considerations that differentiate it from traditional machine learning paradigms. For instance, edge devices have limited resources. Machine learning algorithms that are efficient on traditional systems might not directly translate to embedded platforms due to computational resource constraints. The development of novel optimization techniques that strike a balance between model complexity and resource utilization may be useful.

In deployment and maintenance, unlike traditional setups where models can be updated centrally, edge devices may be deployed in remote or inaccessible locations. Use of edge devices may introduce challenges related to model deployment, updates, and maintenance. Over-the-air updates, model version control, and adaptive learning techniques are useful in ensuring the models stay relevant and performant over time.

Turning to energy efficiency, machine learning algorithms optimized solely for accuracy might not be suitable in context of a battery-powered device, as they could drain the device's energy reserves rapidly. Developing energy-efficient algorithms that balance accuracy with power consumption is essential. Some implementations attempt to tackle such constraint by providing embedded ML engineers with a faster way to reason about an energy budget of the application they are developing.

Hardware acceleration refers to the incorporation of specialized circuitry within microcontrollers to execute specific types of operations more efficiently than generic instructions. For Tiny ML hardware acceleration becomes essential for achieving optimal performance. Two key forms of hardware acceleration are SIMD (Single Instruction, Multiple Data) and DSP (Digital Signal Processing).

SIMD instructions allow a single instruction to operate on multiple data elements in parallel. Such a mechanism can be particularly useful for data-intensive tasks like image processing, audio compression, and vector operations. Rather than executing the same instruction separately for each data element, SIMD allows simultaneous processing, significantly boosting throughput and reducing the number of cycles. Such an approach is especially advantageous for microcontrollers where memory bandwidth and execution speed are limited.

Application-specific DSP instructions may be tailored to accelerate digital signal processing tasks. These tasks involve complex arithmetic operations and are commonly encountered in audio, video, communications, and control systems. DSP instructions often include specialized instructions for MAC operations, saturation arithmetic to prevent overflow/underflow, and other mathematical operations specific to signal processing. By providing hardware support for these operations, DSP instructions enhance performance while minimizing power consumption.

For instance, some of the Cortex-M series of microcontrollers developed by ARM Limited®, integrate hardware acceleration through SIMD and DSP instructions. For instance, the Cortex-M4 and Cortex-M7 processors within such a series include a DSP extension, which introduces instructions optimized for DSP tasks, such as single-cycle multiply-accumulate and fractional arithmetic.

TensorFlow Lite Micro is a lightweight and streamlined version of the popular TensorFlow framework specifically designed for running machine learning models on resource-constrained devices. It addresses the challenges posed by limited memory, processing power, and energy constraints typically associated with embedded systems.

Edge ML is often employed to work with timeseries sensor data. For instance, an accelerometer generating numerical values representing directional movement or a digital microphone supplying data depicting the intensity of sound at distinct temporal points.

DSP may be seamlessly integrated into the edge machine learning pipeline, serving as a precursor to model training and inference. On resource-constrained devices, the efficiency of DSP processes directly impacts the overall efficacy of machine learning applications. Among other things, different DSP algorithms can help to clean up a noisy signal, smooth up anomalies and extract information (or features), from the signal.

Mel-Frequency Energy (MFE) and the Spectrogram are specialized techniques widely utilized in audio signal processing. These methods provide valuable insights into audio characteristics, making them invaluable tools for tasks such as speech recognition and audio classification. While they are frequently employed with audio data, their adaptability extends to the processing of other signal types, such as accelerometer data.

MFE involves evaluating the energy distribution of audio signals or accelerometer data across distinct frequency bands. By computing energy levels in various bands, MFE offers insights into the intensity of different frequency components, providing a way to discern features such as loudness and spectral shape.

Spectrogram focuses on assessing the energy distribution of audio signals or accelerometer data across distinct frequency bands. Through computing energy levels in various bands, the spectrogram offers insights into the intensity of different frequency components.

Some implementations provide an approach for estimating how much energy will be consumed by an inference of an ML model with known architecture on a given single-core low-end embedded system that does not employ PMCs. In some cases, the framework that the device uses for inference is TensorFlow Lite Micro. There are some schemes focused on estimation of energy consumption or power dissipated by general-purpose processors. Some aspects are focused on energy consumption estimation for lower-end tiny ML devices.

Some aspects investigate the energy consumption of other parts of on-device inference, such as DSP pre-processing. Some aspects focus on the inference stage. Some aspects consider the energy consumption of DSP stage as well, in order to provide a more comprehensive estimate of overall energy consumption. Some implementations estimate energy consumption during inference on edge ML devices specifically.

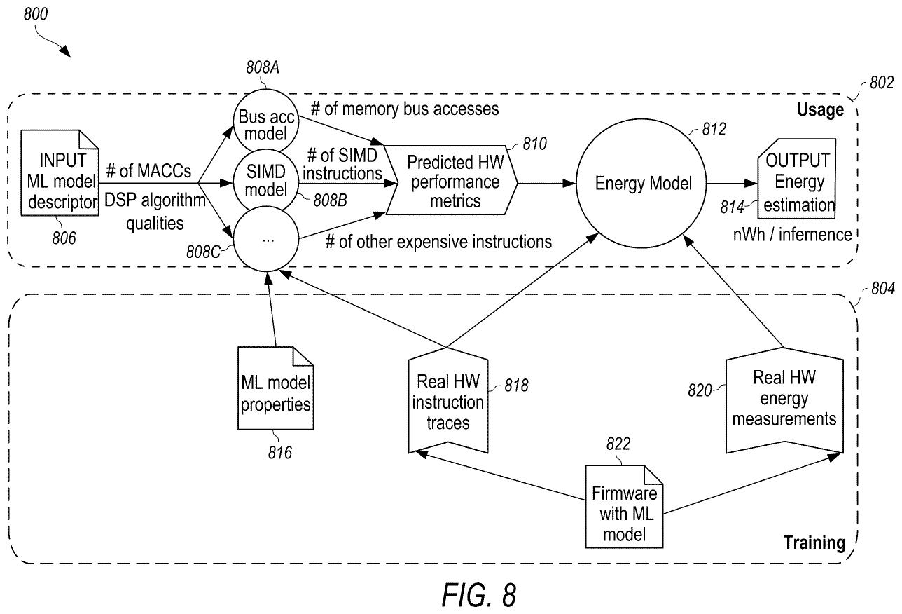

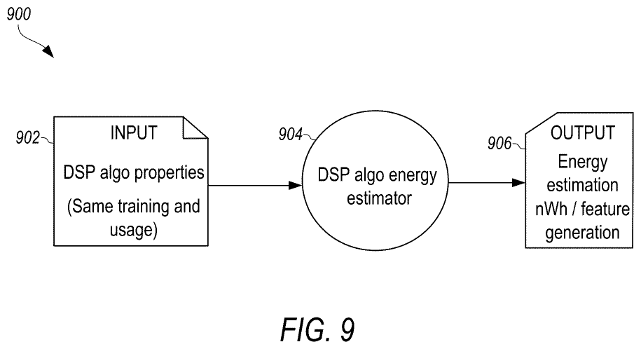

Some implementations use a modular approach to develop a framework that estimates the combined energy consumption of a DSP and/or an inference pass of a CNN on a microcontroller unit (MCU), which are significant aspects of edge machine learning applications. Such a framework includes a chain of estimators for CNN energy inference (as shown in FIG. 8) as well as standalone estimators for DSP algorithms (as shown in FIG. 9). The combined estimation capability is particularly useful for edge machine learning applications, which often involve a mix of signal processing tasks (handled by DSP algorithms) and machine learning tasks (handled by CNN inference). By providing a unified framework for estimating the energy consumption of both types of tasks, such an approach enables developers to make more informed decisions about hardware selection, algorithm optimization, and power management strategies for their edge machine learning applications. The approach can ultimately lead to the development of more energy-efficient and/or cost-effective edge machine learning solutions.

FIG. 8 illustrates an example framework 800 for CNN energy estimation. The framework 800 includes usage 802 and training 804. As shown, the usage 802 includes an input 806 that includes an ML model and a descriptor. An estimator model quantifies a number of MACs in the input and provides these to a bus access model 808A, a SIMD model 808B, and other models 808C. The bus access model 808A outputs a number of memory bus accesses to predicted hardware performance metrics 810. The SIMD model outputs a number of SIMD instructions to the predicted hardware performance metrics 810. The other models 808C output the number of other expensive instructions to the predicted hardware performance metrics 810. The predicted hardware performance metrics 810 are provided to an energy model 812. The energy model generates an output 814 of the energy estimation.

In the training 804, the models 808A-808C are trained based on ML model properties 816 and real hardware instruction traces 818. The energy model 812 is trained based on the real hardware instruction traces 818 and real hardware energy measurements 820. The real hardware instruction traces 818 and the real hardware energy measurements 820 are based on firmware with ML model 822.

FIG. 9 illustrates an example framework 900 for DSP energy estimation. As shown, the input 902 to the DSP algorithm energy estimator 904 includes DSP algorithm properties. The output 906 of the DSP algorithm energy estimator 904 is an energy estimation.

Aspects of the disclosure are directed to estimating how much energy a CNN model and a DSP algorithm will consume on a known device for one forward pass given only the properties of the model (e.g., computational complexity) and the algorithm (parameter values, such as FFT (fast Fourier transform) width). In this way, an estimation can be performed about a certain device without having it at reach and running any code on it.

Target selection may be made from the pool of processors that support deploying inference. Ease of acquiring the Embedded Trace Macrocell (ETM) trace from the processor may be one factor in the selection process.

Multiply-and-accumulate (MAC) operations in CONV and FC layers may account for over 99% of total operations in some CNNs. Additionally, memory bus accesses may be orders of magnitude more energy demanding that any other operation. Therefore, some contributors to the ML inference energy consumption are arithmetic operations and data operations associated with them.

Using the model properties including the number of MACs to estimate energy directly did not result in any sensible performance. In some cases, the relationship of the arithmetic operations to the amount of memory accesses cannot be modeled through a linear relationship.

The amount of executed simple bus access instructions (LDR, LDRB, STR, STRB) include one feature, referred to herein as D1. The amount of SIMD bus accesses (LDRD and STRD) includes another feature, referred to herein as D2. These features, D1 and D2, may be used to determine an estimation of energy consumption on the edge device.

Full (or partial) execution traces may be collected for execution of each of the models. A count of each type of instruction executed by the processor may be available. Different combinations of instructions may be selected and a regression model based on each of these combinations may be fit to estimate the target energy consumption. The combination of D1 and D2 may yield energy estimation results.

Without running the model on-device and capturing the execution trace, obtaining these numbers may be difficult. As one goal of some implementations is to estimate the energy consumption on a given device given the model descriptor, some implementations may be directed to understanding what properties can be derived, and how D1 and D2 relate to these model properties.

TABLE 1
Summary of performance counters

| Code | Name | Description |
|---|---|---|
| D1 | Number of simple bus | The sum of LDR (Load |
| | accesses | Register), LDRB |
| | | (Load Register Byte), STR |
| | | (Store Register), STRB |
| | | (Store Register Byte) |
| | | instructions. These |
| | | instructions work with one |
| | | value at a time. |
| D2 | Number of SIMD bus | LDRD (Load Register |
| | accesses | Double), STRD (Store |
| | | Register Double). These |
| | | instructions load or store |
| | | two values at a time. |

One metric is the computational complexity of a CNN (number of MACs), and it can be calculated knowing the dimensions of convolutional feature maps and filers. In addition to that, one can have an idea about the amount of memory used during an inference pass of the network looking at the number of “parameters”, or output features of each layer. At any given point during inference, a parameter stores the value that will be used as input to the next layer. The sum of parameters between all the layers quantifies the total amount of memory used during the inference.

Using the total number of MACs together with the sum of parameters may be a useful pair of proxies for estimating D1 and D2. These proxies are called P1 and P2, respectively.

Some model layers take less advantage of SIMD bus accesses due to the data locality of their operation. Part of the data includes models that contain residual layers and a much more complicated computation graph than a simplistic manually-designed test CNN. These models have a much higher parameters/MACs ratio suggesting that the same approach to quantifying memory usage may, in some cases, not be applied.

Another identified property is P3—the sum of parameters of layers that are not 1×1 convolutions. That property appeared to be a good proxy for SIMD bus instructions. While it may be difficult to evaluate the exact reason behind such a result, one is left to assume that the data locality of 1×1 convolution operations cannot be exploited by the processor's SIMD bus accesses implementations (LDRD and STRD). A combination of P1, P2, and D1 as estimator features may provide a result for estimating the SIMD bus accesses.

TABLE 2
Summary of ML model properties

| Code | Name | Description |
|---|---|---|
| P1 | MACs | Number of Multiply- |
| | | Accumulate operations |
| | | from the model |
| | | architecture. |
| P2 | Parameters | Sum of output parameters |
| | | of all layers of the network. |
| | | The property quantifies the |
| | | total amount of memory |
| | | used during the inference. |
| P3 | Parameters (subset) | Number of output |
| | | parameters of any layer that |
| | | is not 1x1 convolution. |

Energy measurements may be collected with an external power monitor because on-board power measurement might not be present on some edge devices. A power analyzer may be used. The power analyzer may provide a voltage source to the device to measure the current through an internal measurement resistor. Some kits may offer pins for external power supply that access the power domain of only the MCU, therefore filtering out the contribution of the peripherals and the rest of the board to the current measurements.

Among calculating energy for any selected power measurement period the tool was capable of recording output of the edge device and mapping the time of serial outputs to the timestamps on power recording. The tool enables calculation of energy for any region of interest during the execution of the code on the device by inserting print statements to mark the beginning and end of the region.

Instruction trace may be used with similar markers in assembler code to mark the beginning and end of the same code regions for which the energy consumption is measured. Such a setup provides a streamlined process of collecting the real values of energy consumption and counts of all instructions executed for the same period of time. These data are used as training data for the energy estimation models.

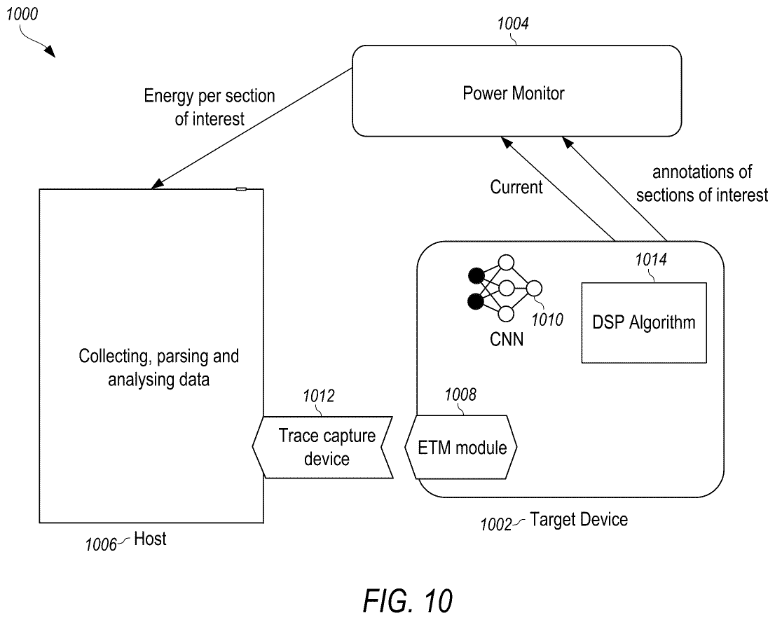

FIG. 10 illustrates an example system 1000 for collecting data to build an energy consumption estimator. As shown, system 1000 includes a target device 1002, a power monitor 1004, and a host 1006. The target device 1002 may be an edge device with a processor. As shown, the target device 1002 includes an Embedded Trace Macrocell (ETM) module 1008, a CNN 1010, and a DSP algorithm 1014. A trace capture device 1012 transmits data from the ETM module 1008 and the CNN 1010 to the host 1006, and the host 1006 collects, parses, and analyzes data. The target device 1002 transmits a current and annotations of sections of interest to the power monitor 1004. The power monitor 1004 transmits energy per section of interest to the host 1006.

A regression-based approach may be employed to estimate the energy consumption, as the nature of the task is predicting a continuous variable based on a set of independent features. The features may be extracted from the instruction traces for each ML model running on the device as described in the previous section.

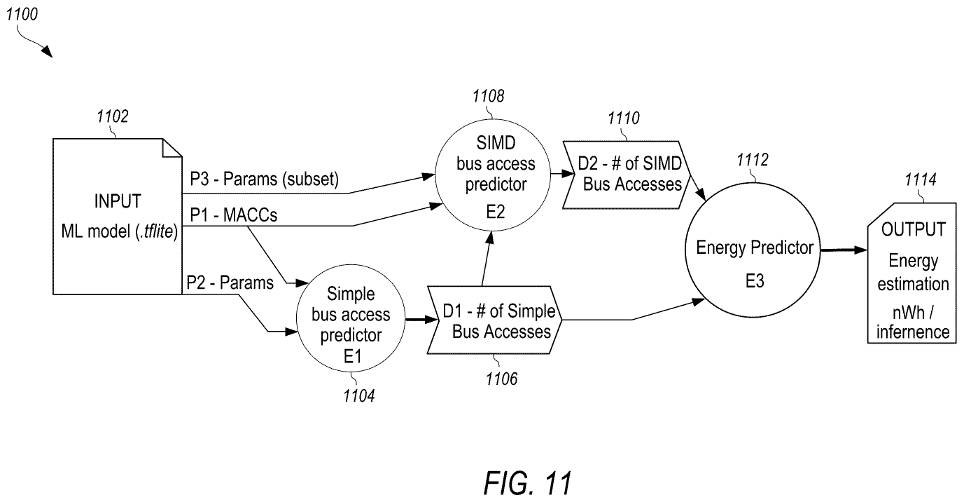

The estimation framework for CNN inference consists of three separate estimators, as illustrated in FIG. 11. The estimators are enumerated in the order of use, since the outputs of some of them serve as inputs for the next ones. Table 3 provides an overview of these estimators with their inputs and outputs.

TABLE 3
Summary of CNN estimators

| Code | Inputs | Output |
|---|---|---|
| E1 | P1, P2 | D1 |
| E2 | P1, P3, D1 | D2 |
| E3 | D1, D2 | Energy Estimation |

Estimator E1 estimates the number of simple bus accesses from properties P1 and P3 of the input “.tflite.” Estimator E2 estimates the number of SIMD bus accesses from properties P1 and P2 of the input “.tflite” file together with D1—number of simple bus accesses. Estimator E3 estimates energy from two performance counters mentioned before—D1—number of simple bus accesses estimated by E1 and D2—number of SIMD bus accesses estimated by E2.

FIG. 11 illustrates an example of a prediction chain 1100, in accordance with aspects of the disclosure. As shown, the input 1102 includes P1, P2, and P3. P1 and P2 are provided to the simple bus access predictor E1 1104, which outputs D1 1106. P1 and P3 are provided to the SIMD bus access predictor E2 1108, which outputs D2 1110. D1 1106 and D2 1108 are provided to the energy predictor E3 1112. The energy predictor E3 1112 provides an output 1114 of the energy estimation.

For DSP, two algorithms commonly utilized for deriving features from timeseries sensor data may be used: Spectrogram and MFE. Spectrograms yield a detailed time-frequency representation of signals, offering insights into dynamic changes in spectral content. Parameters utilized for Spectrogram include Frame length, Frame stride, and FFT length.

MFE provides a more streamlined representation of features, suitable for certain tasks like audio analysis, yet its calculation involves multiple stages that could reduce temporal resolution, constraining its use in scenarios demanding precise timing information. Parameters used for MFE energy estimation are Frame length, Frame stride, Number of Filters and FFT length.

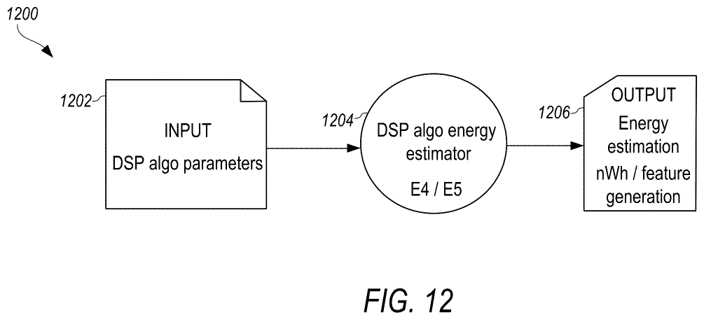

Simplified estimators E4 and E5 were developed for them respectively, utilizing algorithmic parameters as inputs. Their structure is illustrated in FIG. 12.

FIG. 12 illustrates an example of inputs and outputs of DSP estimators 1200, in accordance with aspects of the disclosure. As shown, the input 1202 includes DSP algorithm parameters, which are used to generate the DSP algorithm energy estimator 1204 (E4 and E5). The output 1206 is the energy estimation.

Multivariate linear regression may be used with some estimators implemented in this document. Multivariate linear regression may be used, for example, due to the monotonously growing relationship of energy consumption to some of the measured metrics. An assumption may be made that the consumption includes, for example, a sum of some measured metrics each multiplied by their coefficient. The value of the coefficients for each feature may be the results of fitting the regression models.

Energy consumption is a significant consideration in edge computing, particularly in the context of Edge ML. With the increasing deployment of ML models on edge devices, energy efficiency has become a critical challenge. However, while accuracy and speed are the primary focus in the development of ML models, energy efficiency has often been overlooked.

Some implementations relate to an approach that enables Edge ML developers to optimize energy consumption and provide customers with informed decision-making tools regarding accuracy and energy tradeoffs. It is achieved by allowing to estimate energy consumption a given ML model and a DSP algorithm will yield on a particular device without needing to even have the device at hand.

Some implementations provide benefits compared to deploying the model on device and measuring the energy. Considering an estimator model for the given device is already fitted (either from the previously collected trances and energy measurements or derived from another device of the same class), one benefit is that the time overhead used to compile the firmware, flash it to the device and perform physical measurements is completely avoided, providing a rapid iteration speed. A substantial amount of effort may be used to collect the data if no base estimator for a device under test exists in terms of CNN inference energy estimation. Collecting data to create an estimator for DSP algorithms from scratch is much less cumbersome, but may still result in effort.

Some aspects include factors that contribute to energy consumption of inferencing CNNs on an arm-based MCU. The two performance counters, D1 and D2, may contribute the most to energy consumption. Knowing the amount of executed simple bus access instructions (LDR, LDRB, STR, STRB) and the amount of SIMD bus accesses (LDRD and STRD) is useful to obtain an estimation of energy consumption on the given device. These performance metrics can then be estimated in sequence from ML model properties.

The energy consumption of DSP differs from that of CNN. CNN computational complexity has a complex indirect relation to energy consumption through performance metrics that the processor executes during the inference of the model. In contrast, consumption of DSP algorithms like MFE and Spectrogram can be quantified using the algorithmic properties that define the computational complexity of the algorithm configuration, such as a number of filters and a length of FFT.

Some aspects use a multivariate linear regression model. It should be noted that other models, for example, a random forest regression model, may be used in place of the multivariate linear regression model in conjunction with the disclosed technology. Also, the disclosed models may be extended to focus, for example, on how much each layer of a CNN contributes to the total inference energy consumption. The resulting information may be used, for example, to adjust the CNN to reduce its energy consumption.

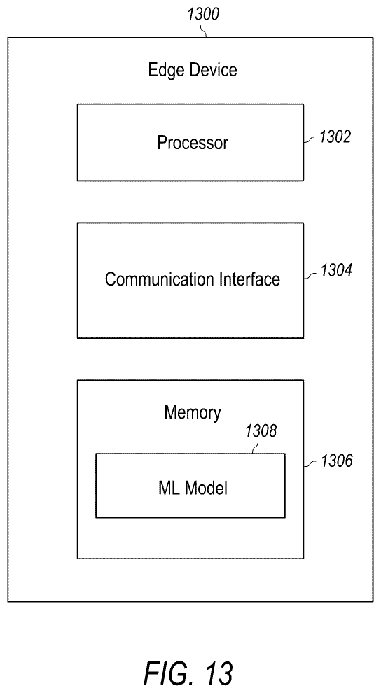

FIG. 13 illustrates an example of an edge device 1300 configured to perform machine learning inference, in accordance with aspects of the disclosure. As shown, the edge device 1300 includes a processor 1302, a communication interface 1304, and memory 1306. The processor 1302 may include one or more processors. The processor 1302 may include at least one or a microcontroller or an embedded system. The communication interface 1304 may include at least one of a network interface, a radio interface, or a wired connection interface. The communication interface 1304 allows the edge device to communicate with other device(s).

The memory 1306 stores data and/or instructions for execution by the processor 1302. The memory 1306 may include cache unit(s) and/or storage unit(s). As shown, the memory 1306 stores an ML model 1308 which may be executed by the processor 1302. Executing the ML model 1308 may include performing inference or, alternatively, training or testing the ML model 1308.

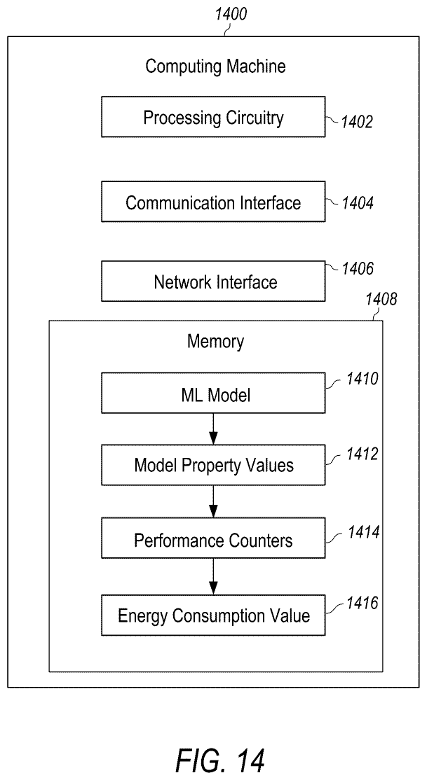

FIG. 14 illustrates an example of a computing device 1400 configured to generate an estimate of energy consumption (e.g., by the edge device 1300 in performing inference with the ML model 1308), in accordance with aspects of the disclosure. The computing device 1400 may incorporate all or a portion of the components of the computing device 500. As shown, the computing device 1400 includes processing circuitry 1402, a communication interface 1404, a network interface 1406, and memory 1408.

The processing circuitry 1402 includes one or more processors. The one or more processors may be arranged in processing unit(s), such as CPU(s) or GPU(s). The processing circuitry 1402 may include at least one a CPU or a GPU.

The communication interface 1404 may include at least one of a wired interface, a radio interface, or a network-based communication interface for communicating with the edge device 1300 to obtain data associated with operation of the edge device 1300, as described herein. The network interface 1406 may include one or more network interface cards (NICs) to configure the computing device 1400 to communicate over a network, for example, at least one of the Internet, a Wi-Fi® network, an Ethernet network, a cellular network, or a satellite network. In some cases, the network interface 1406 includes the communication interface 1404 and/or the communication interface 1404 is a component of the network interface 1406. In some cases, the network interface 1406 is separate and distinct from the communication interface 1404.

The memory 1408 stores data and/or instructions for execution by the processing circuitry 1402. The memory 1408 may include cache unit(s) and/or storage unit(s). As shown, the memory 1408 stores a ML model 1410, model property values 1412, performance counters 1414, and an energy consumption value 1416.

The ML model 1410 may correspond to the ML model 1308 of the edge device 1300. The model property values 1412 may be obtained, by the processing circuitry 1402, based on the ML model 1410. The model property values 1412 may include P1, P2, and/or P3. The performance counters 1414 may be obtained, by the processing circuitry 1402, based on the model property values 1412. The performance counters 1414 may include D1 and/or D2. The energy consumption value 1416 may be obtained, by the processing circuitry 1402, based on the performance counters 1414. The energy consumption value 1416 may be provided as output, for example, to a display unit of the computing device 1400 or to a data repository (e.g., a database) outside the computing device 1400. The energy consumption value 1416 may be stored in the memory 1408 of the computing device 1400.

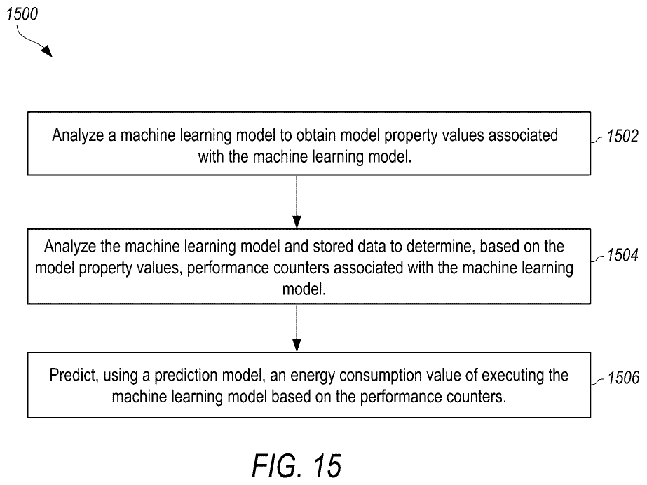

FIG. 15 is a flowchart of an example technique 1500 for predicting energy consumption, in accordance with aspects of the disclosure. The technique 1500 may be performed, for example, by the computing device 1400, the computing device 500, or another computer.

At 1502, a computing device (e.g., the computing device 1400 or the computing device 500) analyzes a machine learning model to obtain model property values (e.g., the model property values 1412) associated with the machine learning model (e.g., the ML model 1410 or the ML model 1308).

At 1504, the computing device analyzes the machine learning model and stored data to determine, based on the model property values, performance counters associated with the machine learning model (e.g., the performance counters 1414). The machine learning model may execute on a processor (e.g., the processor 1302 of the edge device 1300). The performance counters may include a number and a type of memory accesses associated with the machine learning model executing on the processor.

At 1506, the computing device predicts, using a prediction model, an energy consumption value of executing the machine learning model based on the performance counters. An example of the energy consumption value is the energy consumption value 1416). Executing the machine learning model on the processor may include an inference with the machine learning model on the processor. The prediction model may be a regression-based model applied to the performance counters.

In some cases, the machine learning model includes a convolutional neural network. The model property values include at least one of (P1) a number of multiply-accumulate operations from an architecture of the machine learning model, (P2) a sum of output parameters of layers of the convolutional neural network, or (P3) a number of output parameter of any layer of the layers that is not a 1×1 convolution. The performance counters may include at least one of (D1) a number of simple bus accesses, or (D2) a number of single instruction multiple data bus accesses. The number of simple bus accesses may include a sum of a number of load register instructions, a number of load register byte instructions, a number of store register instructions, and a number of store register byte instructions. The number of single instruction multiple data bus accesses may be based on a number of load register double instructions and a number of store register double instructions.

In some implementations, (D1) the number of simple bus accesses is determined based on (P1) the number of multiply-accumulate operations and (P2) the sum of output parameters of the layers of the convolutional neural network. In some implementations, (D2) the number of single instruction multiple data bus accesses is determined based on (P1) the number of multiply-accumulate operations, (P3) the number of output parameters of any layer of the layers that is not the 1×1 convolution, and (D1) the number of simple bus accesses.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, engines, circuits, and algorithm steps described in connection with the aspects disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, engines, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules, engines, or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for predicting energy consumption of a machine learning model, comprising: at least one memory; and at least one processor coupled to the at least one memory and configured to: analyze a machine learning model to obtain model property values associated with the machine learning model; analyze the machine learning model and stored data to determine, based on the model property values, performance counters associated with the machine learning model; and predict, using a prediction model, an energy consumption value of executing the machine learning model based on the performance counters.

Aspect 2. The apparatus of Aspect 1, wherein the machine learning model executes one or more inference operations.

Aspect 3. The apparatus of any of Aspects 1-2, wherein the machine learning model comprises a convolutional neural network, wherein the model property values comprise at least one of: a number of multiply-accumulate operations from an architecture of the machine learning model, a sum of output parameters of layers of the convolutional neural network, or a number of output parameter of any layer of the layers that is not a 1×1 convolution.

Aspect 4. The apparatus of Aspect 3, wherein the performance counters comprise at least one of: a number of simple bus accesses, or a number of single instruction multiple data bus accesses.

Aspect 5. The apparatus of Aspect 4, wherein the number of simple bus accesses comprises a sum of a number of load register instructions, a number of load register byte instructions, a number of store register instructions, and a number of store register byte instructions.

Aspect 6. The apparatus of any of Aspects 4-5, wherein the number of single instruction multiple data bus accesses is based on a number of load register double instructions and a number of store register double instructions.

Aspect 7. The apparatus of any of Aspects 4-6, wherein the number of simple bus accesses is determined based on the number of multiply-accumulate operations and the sum of output parameters of the layers of the convolutional neural network.

Aspect 8. The apparatus of any of Aspects 4-7, wherein the number of single instruction multiple data bus accesses is determined based on the number of multiply-accumulate operations, the number of output parameter of any layer of the layers that is not the 1×1 convolution, and the number of simple bus accesses.

Aspect 9. The apparatus of any of Aspects 1-8, wherein the prediction model comprises a regression-based model applied to the performance counters.

Aspect 10. The apparatus of any of Aspects 1-9, wherein the performance

counters comprise a number and a type of memory accesses associated with the machine learning model.

Aspect 11. The apparatus of any of Aspects 1-10, wherein the machine learning model executes on one or more additional processors of an edge device.

Aspect 12. The apparatus of any of Aspects 1-12, wherein the stored data is associated with the one or more additional processors.

Aspect 13. The apparatus of any of Aspects 1-13, wherein the edge device is separate and distinct from the apparatus.

Aspect 14. A method for predicting energy consumption of a machine learning model, the method comprising: analyzing a machine learning model to obtain model property values associated with the machine learning model; analyzing the machine learning model and stored data to determine, based on the model property values, performance counters associated with the machine learning model; and predicting, using a prediction model, an energy consumption value of executing the machine learning model based on the performance counters.

Aspect 15. The method of Aspect 14, wherein the machine learning model executes one or more inference operations.

Aspect 16. The method of any of Aspect 14-15, wherein the machine learning model comprises a convolutional neural network, wherein the model property values comprise at least one of: a number of multiply-accumulate operations from an architecture of the machine learning model, a sum of output parameters of layers of the convolutional neural network, or a number of output parameter of any layer of the layers that is not a 1×1 convolution.

Aspect 17. The method of any of Aspect 14-16, wherein the performance counters comprise at least one of: a number of simple bus accesses, or a number of single instruction multiple data bus accesses.

Aspect 18. A non-transitory computer-readable medium is provided that has stored thereon instructions that, when executed by one or more processors, cause the one or more processors to: analyze a machine learning model to obtain model property values associated with the machine learning model; analyze the machine learning model and stored data to determine, based on the model property values, performance counters associated with the machine learning model; and predict, using a prediction model, an energy consumption value of executing the machine learning model based on the performance counters.

Aspect 19. The non-transitory computer-readable medium of Aspect 18, wherein the machine learning model executes one or more inference operations.

Aspect 20. The non-transitory computer-readable medium of any of Aspects 18-19, wherein the machine learning model comprises a convolutional neural network, wherein the model property values comprise at least one of: a number of multiply-accumulate operations from an architecture of the machine learning model, a sum of output parameters of layers of the convolutional neural network, or a number of output parameter of any layer of the layers that is not a 1×1 convolution.

Aspect 21. A non-transitory computer-readable medium is provided that has

stored thereon instructions that, when executed by one or more processors, cause the one or more processors to perform operations according to any of Aspects 1-17

Aspect 22: An apparatus including one or more means for performing

operations according to any of Aspects 1-17.

What is claimed is:

1. An apparatus for predicting energy consumption of a machine learning model, comprising:
at least one memory; and
at least one processor coupled to the at least one memory and configured to:
analyze a machine learning model to obtain model property values associated with the machine learning model;
analyze the machine learning model and stored data to determine, based on the model property values, performance counters associated with the machine learning model; and
predict, using a prediction model, an energy consumption value of executing the machine learning model based on the performance counters.

2. The apparatus of claim 1, wherein the machine learning model executes one or more inference operations.

3. The apparatus of claim 1, wherein the machine learning model comprises a convolutional neural network, wherein the model property values comprise at least one of: a number of multiply-accumulate operations from an architecture of the machine learning model, a sum of output parameters of layers of the convolutional neural network, or a number of output parameter of any layer of the layers that is not a 1×1 convolution.

4. The apparatus of claim 3, wherein the performance counters comprise at least one of: a number of simple bus accesses, or a number of single instruction multiple data bus accesses.

5. The apparatus of claim 4, wherein the number of simple bus accesses comprises a sum of a number of load register instructions, a number of load register byte instructions, a number of store register instructions, and a number of store register byte instructions.

6. The apparatus of claim 4, wherein the number of single instruction multiple data bus accesses is based on a number of load register double instructions and a number of store register double instructions.

7. The apparatus of claim 4, wherein the number of simple bus accesses is determined based on the number of multiply-accumulate operations and the sum of output parameters of the layers of the convolutional neural network.

8. The apparatus of claim 4, wherein the number of single instruction multiple data bus accesses is determined based on the number of multiply-accumulate operations, the number of output parameter of any layer of the layers that is not the 1×1 convolution, and the number of simple bus accesses.

9. The apparatus of claim 1, wherein the prediction model comprises a regression-based model applied to the performance counters.

10. The apparatus of claim 1, wherein the performance counters comprise a number and a type of memory accesses associated with the machine learning model.

11. The apparatus of claim 1, wherein the machine learning model executes on one or more additional processors of an edge device.

12. The apparatus of claim 11, wherein the stored data is associated with the one or more additional processors.

13. The apparatus of claim 11, wherein the edge device is separate and distinct from the apparatus.

14. A method for predicting energy consumption of a machine learning model, the method comprising:
analyzing a machine learning model to obtain model property values associated with the machine learning model;
analyzing the machine learning model and stored data to determine, based on the model property values, performance counters associated with the machine learning model; and
predicting, using a prediction model, an energy consumption value of executing the machine learning model based on the performance counters.

15. The method of claim 14, wherein the machine learning model executes one or more inference operations.

16. The method of claim 14, wherein the machine learning model comprises a convolutional neural network, wherein the model property values comprise at least one of: a number of multiply-accumulate operations from an architecture of the machine learning model, a sum of output parameters of layers of the convolutional neural network, or a number of output parameter of any layer of the layers that is not a 1×1 convolution.

17. The method of claim 16, wherein the performance counters comprise at least one of: a number of simple bus accesses, or a number of single instruction multiple data bus accesses.

18. A non-transitory computer-readable medium is provided that has stored thereon instructions that, when executed by one or more processors, cause the one or more processors to:
analyze a machine learning model to obtain model property values associated with the machine learning model;
analyze the machine learning model and stored data to determine, based on the model property values, performance counters associated with the machine learning model; and
predict, using a prediction model, an energy consumption value of executing the machine learning model based on the performance counters.

19. The non-transitory computer-readable medium of claim 18, wherein the machine learning model executes one or more inference operations.

20. The non-transitory computer-readable medium of claim 18, wherein the machine learning model comprises a convolutional neural network, wherein the model property values comprise at least one of: a number of multiply-accumulate operations from an architecture of the machine learning model, a sum of output parameters of layers of the convolutional neural network, or a number of output parameter of any layer of the layers that is not a 1×1 convolution.
